(19) United States
(12) Patent Application Publication
(10) Pub. No.: US 2013/0079441 A1
(43) Pub. Date: Mar. 28, 2013

(54) STARCH/RUBBER LATEX COMPOUND AND METHOD FOR MANUFACTURING SAME USING COUPLING REAGENT

(71) Applicants: Hyung Seok Kim, Seoul (KR); Hyun Chul Cho, Seoul (KR); Ur Ryong Cho, Cheonan (KR); Seok Min Jang, Cheonan (KR); Jong Hyuk Lim, Cheongju (KR)

(72) Inventors: Hyung Seok Kim, Seoul (KR); Hyun Chul Cho, Seoul (KR); Ur Ryong Cho, Cheonan (KR); Seok Min Jang, Cheonan (KR); Jong Hyuk Lim, Cheongju (KR)

(73) Assignees: Korea University of Technology and Education Industry-University Cooperation Foundation, Cheonan (KR); Hyundai Motor Company, Seoul (KR)

(21) Appl. No.: 13/297,749

(22) Filed: Nov. 16, 2011

(30) Foreign Application Priority Data
Sep. 23, 2011 (KR) 10-2011-0096585

(51) Int. Cl. C08L 7/00; C08K 13/06; C08L 7/02

(52) U.S. Cl. 524/52

(57) ABSTRACT

Disclosed is a rubber composition obtained by chemically blending rubber with a filler, particularly in which Latex rubber is directly blended with a starch solution obtained by gelatinizing starch in water. Herein, as a coupling agent between Latex rubber and starch, resorcinol-formaldehyde is used. By this, a vulcanized rubber compound is prepared. When resorcinol-formaldehyde is used as a coupling agent during the blending of the Latex rubber with the gelatinized starch solution, it is possible to solve the problem of tensile strength lowering caused by low affinity with rubber. Furthermore, it is possible to inhibit starch loss caused by high water-solubility, during the blending of starch in a liquid state. Also, the physical property of the vulcanized rubber compound can be varied according to the amount of the added coupling agent.

### CROSS-REFERENCE TO RELATED APPLICATION

This application claims under 35 U.S.C. §119(a) the benefit of Korean Patent Application No. 10-2011-0096585 filed on Sep. 23, 2011, the entire contents of which are incorporated herein by reference.

### BACKGROUND

(a) Technical Field

The present invention relates to a rubber composition, particularly a rubber composition which includes starch as a filler for improving affinity with rubber, Latex rubber, and resorcinol-formaldehyde as a coupling agent, and methods for manufacture thereof.

(b) Background Art

In the tire industry, carbon black has been mainly used as a filler due to its high formability in its use, low cost, volume increasing effect, and quality control and related rubber technology which has been established by accumulated experience. However, carbon black is produced from crude oil, such as heavy oil derived from petroleum or coal tar, and thus its cost inevitably depends on the prime cost of the crude oil. Moreover, as crude oil reserves are exhausted, its cost increase, and its price competitiveness is continuously reduced. Also, since carbon black is obtained through incomplete combustion or thermal decomposition during a manufacturing process, the production of carbon black results in unavoidable environmental problem caused by carbon dioxide generation, etc. and subsequently, will result in increased environmental regulations.

Accordingly, highly price-competitive and environmentally friendly starch has been spotlighted as a potential filler substitute for carbon black. Starch is not only recyclable, cheap, and environmentally friendly, but it is also harmless to a human body, and highly soluble in water. Thus, use of starch can possibly reduce contamination in the workplace and the surroundings. However, starch has a large particle size, and thus it is difficult to directly physically mix starch with a rubber matrix. Furthermore, starch is difficult to disperse.

Also, in order to obtain a blend composition of raw rubber and starch, a method must be developed for chemically bonding these two materials in view of the hydrophilicity of starch which results in loss, and the lack of affinity between raw rubber and starch.

In an attempt to provide such a method, Latex rubber and starch as a filler are used. As the filler, modified starch, which is obtained by oxidizing starch and esterifying a hydroxyl group, is used. The gelatinized solution of the modified starch is excellent in viscosity stability and water holding capacity. However, unlike carbon black, it is difficult to mechanically disperse the starch due to a strong binding strength between starch particles. Accordingly, rubber in a Latex state is blended with gelatinized starch. However, this method causes several problems. First, it is not easy to disperse hydrophilic and semi-crystalline starch in amorphous and hydrophobic rubber, and thus the two materials are not chemically bonded to each other due to the low affinity between them. Second, the starch is hydrophilic, and thus is more easily dissolved in water than in rubber. This causes a loss of the starch. As a result, it is impossible to control the content of the filler, which is problematic.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The inventors of the present invention have developed a novel method for blending Latex rubber with a gelatinized starch solution. According to embodiments of the present invention, resorcinol-formaldehyde is used as a coupling agent so as to improve the affinity of the rubber with the starch. Such a coupling can minimize a reduction in mechanical properties such as tensile strength, and can also greatly increase the amount of starch which can be loaded. Further, by varying the composition ratio of resorcinol-formaldehyde, it is possible to change the physical property of the final vulcanized rubber compound.

Accordingly, an object of the present invention is to provide a method for using a coupling agent in the blending of starch with Latex rubber. Through the use of the coupling agent of the invention, it is possible to inhibit starch loss during the blending between starch and Latex rubber, in a solution state. Furthermore, during dispersion of the starch in the Latex rubber, it is possible to solve the problem caused by low affinity between the two materials. Also, the content of the coupling agent can be varied so as to improve and adjust the physical properties of the vulcanized rubber compound as desired, which widens the potential uses of the present vulcanized rubber compound containing starch as a filler.

In the present invention, by the use of resorcinol-formaldehyde, an OH-group of starch reacts with a thiol group of a coupling agent, and also, an OH-group of the coupling agent reacts with a double bond of rubber. Thus, a chemical bond between the two materials is carried out without a loss of starch.

In one aspect, the present invention provides a rubber composition including a synthesis of rubber/starch, which includes about 100 parts by weight of rubber, about 20-100 parts by weight of starch filler, about 1-10 parts by weight of a coupling agent, and about 1-10 parts by weight of a coagulant.

Other aspects and exemplary embodiments of the invention are discussed infra.

Through the embodiments of the present invention, the present invention provides the effects below.

The inventive final composition is characterized in that it has advantages of a conventional rubber compound containing starch as a filler, and further includes a coupling agent. Due to the use of a coupling agent, when rubber is coupled with starch, very little starch is lost. This makes it possible to control the amount of the filler without a mechanical method. Also, through adjustment of the amount of the coupling agent, the physical properties of the composition can be controlled. This widens the potential applications of the rubber compound including the starch filler, and makes it possible to use the rubber compound in a broader variety of products.

Also, through the use of the present coupling agent, it is possible to reduce the problem of sudden mechanical property lowering caused by the addition of starch. Furthermore, there is an advantage in that the content of starch can be 100 phr (parts by weight of rubber blend) or more.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value. Unless otherwise clear from context, all numerical values provided herein are modified by the term about.

According to one embodiment of the present invention, the present invention provides a rubber composition including a synthesis of rubber/starch, particularly a combination of rubber, starch filler, and a coupling agent, and which may further include a coagulant. According to an embodiment of the invention, the rubber composition includes about 100 parts by weight of rubber, about 20-100 parts by weight of starch filler, about 1-10 parts by weight of a coupling agent, and about 1-10 parts by weight of a coagulant.

According to a preferred embodiment of the present invention, the rubber includes Latex rubber.

Generally, there is no limitation in the kind of the Latex rubber as long as it includes about 20˜100 parts by weight of solid content. Also, the Latex rubber may be used through dilution or concentration. Preferably, Latex rubber including about 35˜70 parts by weight of solid content is used. Some examples of the Latex rubber used in the present invention include, but are not limited to, natural rubber, SBR rubber, polychloroprene rubber, nitrile rubber, butyl rubber, butadiene rubber, isoprene rubber, ethyl propylene rubber, silicon rubber, fluororubber, urethane rubber, acryl rubber, etc.

According to a preferred embodiment of the present invention, the starch filler is a gelatinized solution including a powder type of starch gelatinized in distilled water. Gelatinized starch may be basically prepared through distilled water, and the composition ratio of water to starch (w:w) is preferably about 4˜5:1. When the composition ratio of water to starch is greater than about 5:1, the gelatinized solution is too watery, which reduces the reactivity with Latex rubber. On the other hand, when the composition ratio is lower than about 4:1, the viscosity becomes too thick. Also, the increase of the content of starch results in a further sudden increase in viscosity. For example, a gelatinized solution obtained by gelatinizing starch in distilled water for about 1 hour is dropped in a Latex rubber solution through a dropping panel. According to aspects of the invention, the Latex rubber solution is obtained by adding resorcinol-formaldehyde to Latex rubber, followed by stirring for about 10 minutes. This dropping method beneficially increases dispersibility and chemical reactivity.

According to a preferred embodiment of the present invention, the starch filler is modified starch which is obtained by oxidizing starch and esterifying a hydroxyl group.

According to a preferred embodiment of the present invention, the coupling agent is resorcinol-formaldehyde.

The resorcinol-formaldehyde may be added in a suitable amount with respect to wt % of rubber in order to increase the coupling capability between rubber and starch. It is further possible to control physical properties of a final vulcanized rubber compound based on the content of the resorcinol-formaldehyde, and thus the content of the resorcinol-formaldehyde can further take into consideration the desired physical properties of the product.

The Latex rubber is mixed with the gelatinized starch solution and the resorcinol-formaldehyde, and the resultant mixture is mixed with a coagulant. Then, the coagulated composition is dried for about 48 hours. Accordingly, a rubber/starch composition, from which moisture has been removed, can be obtained.

According to a preferred embodiment of the present invention, the coagulant is a single compound or a mixture of at least two compounds selected from the group consisting of calcium chloride, magnesium sulfate, magnesium chloride and sodium chloride.

According to a preferred of the present invention, the coagulant is solvated for use through a solvent such as methanol, ethanol and water.

According to another embodiment of the present invention, the rubber composition is a vulcanized rubber composition which includes one or more additional additives such as a vulcanizing agent, a vulcanization accelerator, a vulcanization activator, and an oxidizer.

When the rubber/starch composition is added with a vulcanizing agent, a vulcanization accelerator, a vulcanization activator, and/or an oxidizer, and the mixture is suitably blended (e.g., on a two-roll mill (60˜70° C.)), a vulcanized rubber compound is obtained which is sufficiently dispersed without a loss of starch.

The vulcanization may be carried out by a conventional rubber vulcanizing method. Specifically, according to the use or the composition, and the requirement of a processing time, the contents of organic and inorganic compounding ingredients such as a vulcanizing agent, a vulcanization accelerator, a vulcanization activator, and an oxidizer may be suitably adjusted.

### EXAMPLES

The following examples illustrate the invention and are not intended to limit the same.

Hereinafter, Examples of the present invention will be described. However the Examples are according to a preferred embodiment the present invention, and the present invention is not limited thereto.

(1) Gelatinization of Starch

A constant-temperature bath was filled with water, and the temperature was adjusted to 90° C. A digital stirrer was provided with an impeller, and 500 g of distilled water and 100 g of starch were introduced into a reactor. Then, the reactor was provided in the stirrer, and stirred at 120 RPM for about 1 hour. After 1 hour, the temperature of the water in the constant-temperature bath was lowered to room temperature. During this process, while the stirrer was in an “on” state, a gelatinizing step was carried out.

(2) Preparation of a Coupling Agent and Pretreatment of Latex Rubber

At a room temperature, in a pyrex reactor provided with a stirrer, natural Latex rubber at a concentration of about 60% was added with 1˜5 phr of resorcinol-formaldehyde. Then, the mixture was stirred by the stirrer for about 10 minutes. Herein, the resorcinol-formaldehyde has a ratio of resorcinol:formaldehyde (w:w)=1:3, which was dissolved in distilled water. Then, the resorcinol-formaldehyde was added to natural Latex rubber.

(3) Coagulation of Rubber Applied with Starch as a Filler

About 60 g of anhydrous calcium chloride was added to about 3 L of methanol, and the solution was stirred until the anhydrous calcium chloride (solid content) was completely dissolved and became a transparent liquid. Then, a predetermined amount of the solution was taken out, and added to the above prepared starch-Latex rubber compound. Then, the starch-Latex rubber compound added with the solution was coagulated. In this state, the coagulated starch-Latex rubber compound contained moisture, and thus was sufficiently spread out. The starch-Latex rubber compound was subsequently cut into an appropriate size because after a drying step, the starch-Latex rubber compound becomes very hard. Then, the starch-Latex rubber compound was dried for 48 hours at about 100° C. so as to completely remove the moisture.

(4) Preparation of Vulcanized Rubber Compound

The combination formula of the compound is noted in Table 1.

TABLE 1

| Composition | unit | Ex. 1 | Ex. 2 | Ex. 3 | Ex. 4 | Ex. 5 | Comp. Ex. |
|---|---|---|---|---|---|---|---|
| Natural rubber | g | 200 | 200 | 200 | 200 | 200 | 200 |
| Starch | phr | 100 | 100 | 100 | 100 | 100 | 100 |
| Coupling agent | g | 1 | 2 | 3 | 4 | 5 | 0 |
| (resorcinol- | | | | | | | |
| formaldehyde) | | | | | | | |
| Zinc oxide | g | 10 | 10 | 10 | 10 | 10 | 10 |
| (ZnO2) | | | | | | | |
| Stearic acid | g | 2 | 2 | 2 | 2 | 2 | 2 |
| Antioxidant (RD) | g | 2 | 2 | 2 | 2 | 2 | 2 |
| Sulfur | g | 2 | 2 | 2 | 2 | 2 | 2 |
| Accelerator (TT) | g | 1 | 1 | 1 | 1 | 1 | 1 |
| Accelerator (D) | g | 1 | 1 | 1 | 1 | 1 | 1 |
| Accelerator (DM) | g | 2 | 2 | 2 | 2 | 2 | 2 |

The case of no addition of resorcinol-formaldehyde was omitted because it cannot be an accurate comparative example due to the loss of starch as a filler.

### Examples 1 to 5

### Vulcanized Rubber Compound Obtained through Blending with 1˜5 phr of Resorcinol-Formaldehyde

Natural-starch, resorcinol-formaldehyde, zinc oxide, stearic acid, antioxidant, sulfur, and an accelerator, obtained through blending, were weighed according to the combination formula noted in Table 1 above, and were blended on a two-roll mill (60˜70° C.). A rubber sheet taken out with a thickness of 2 mm (t) was subjected to heating and pressure at 160° C. for a period of time until the sheet was increased two times in thickness (t) (e.g., in this case, the sheet was subjected to the noted heating and pressure until its thickness became 4 mm), and then vulcanized.

### Comparative Example

### Rubber Compound without Addition of a Coupling Agent (Preparation of Test Sample is the Same as that in the Examples)

Comparison of Physical Properties of Vulcanized Rubber Compounds

Tensile strength, 300% modulus, and elongation were tested by a universal testing device (Tinius-olsen H5KT0401). Herein, the tensile strength was tested in accordance with ASTM D-412, the tear strength was tested in accordance with ASTM D-624, and the hardness was tested by a Shore A hardness tester. The results are noted in Table 2 below.

TABLE 2

| Physical | | | | | | Comp. |
|---|---|---|---|---|---|---|
| property | Ex 1 | Ex 2 | Ex 3 | Ex 4 | Ex 5 | Ex. |
| Tensile strength | 13.39 | 10.92 | 15.8 | 16.3 | 13.99 | 16.9 |
| (MPa) | | | | | | |
| 300% Modulus | 3.78 | 4.07 | 4.38 | 4.08 | 4.35 | 5.12 |
| (MPa) | | | | | | |
| Elongation | 860 | 720 | 890 | 920 | 790 | 1720 |
| (%) | | | | | | |
| Tear strength | 51 | 57 | 60 | 58 | 65 | 31 |
| Hardness | 64 | 64 | 66 | 65 | 64 | 38 |
| (Shore A) | | | | | | |

As noted in Table 2 above, the final vulcanized rubber compound containing starch as a filler is excellent in hardness and tear strength. It is demonstrated that even though 100 phr of starch was added, the lowering of tensile strength was not significant. Also, according to a physical property required for a rubber product, the content of a coupling agent may be changed so as to adjust the tensile strength and the elongation.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A rubber composition comprising a synthesis of rubber/starch, which comprises about 100 parts by weight of rubber, about 20-100 parts by weight of starch filler, about 1-10 parts by weight of a coupling agent, and about 1-10 parts by weight of a coagulant.

2. The rubber composition of claim 1, wherein the rubber is latex.

3. The rubber composition of claim 1, wherein the starch filler is a gelatinized solution comprising a powder type of starch gelatinized in distilled water.

4. The rubber composition of claim 1, wherein the starch filler is modified starch which is obtained by oxidizing starch and esterifying a hydroxyl group.

5. The rubber composition of claim 1, wherein the coupling agent is resorcinol-formaldehyde.

6. The rubber composition of claim 1, wherein the coagulant is a single compound or a mixture of at least two compounds selected from the group consisting of calcium chloride, magnesium sulfate, magnesium chloride and sodium chloride.

7. The rubber composition of claim 6, wherein the coagulant is solvated for use through a methanol, ethanol or water solvent.

8. A vulcanized rubber composition which is obtained by adding a vulcanizing agent, a vulcanization accelerator, a vulcanization activator, and an oxidizer to the rubber composition according to claim 1.

9. A method for forming a rubber composition comprising:
mixing about 100 parts by weight of rubber, about 20-100 parts by weight of starch filler, and about 1-10 parts by weight of a coupling agent;
adding about 1-10 parts by weight of a coagulant to form a coagulated composition; and
drying the coagulated composition.

10. The method of claim 9, wherein the coupling agent is resorcinol-formaldehyde.

11. The method of claim 9, further comprising adding a vulcanizing agent, a vulcanization accelerator, a vulcanization activator, and/or an oxidizer, to thereby form a vulcanized rubber composition.
